(19) United States
(12) Patent Application Publication
(10) Pub. No.: US 2020/0242717 A1
(43) Pub. Date: Jul. 30, 2020

(54) PREVENTION OF IDENTIFICATION DOCUMENT FORGERY THROUGH USE OF BLOCKCHAIN TECHNOLOGY AND BIOMETRICS BASED AUTHENTICATION

(71) Applicant: International Business Machines Corporation, Armonk, NY (US)

(72) Inventors: PRANAB AGARWAL, SOUTHPORT (AU); CRAIG PEARSON, ROBINA TOWN CENTRE (AU); MICHAEL E. HOOD, SUNNYBANK HILLS (AU)

(21) Appl. No.: 16/262,159

(22) Filed: Jan. 30, 2019

(51) Int. Cl. G06Q 50/26; G06F 16/955; G06F 16/28

(52) U.S. Cl. CPC G06Q 50/265; G06F 16/28; G06F 16/9554

(57) ABSTRACT

A processor-implemented method manages an identification document (ID) that is displayed on an electronic device. One or more processors (e.g., within an identity document manager) receive a set of profile details about an entity. The processor(s) send the set of profile details about the entity to a blockchain system that generates a blockchain from the set of profile details about the entity. The processor(s) generate a barcode from a hash of the blockchain, and transmit the barcode to an entity device. The processor(s) subsequently receive a new barcode from an entity verification device. The processor(s) compare information in the new barcode that is received from the entity verification device to information in the blockchain that the identity document manager received from the blockchain system. In response to the two sets of information matching, the processor(s) transmit entity authorization instructions to the entity verification device.

### BACKGROUND

The present invention relates to the field of passports, and particularly to the issuance of identification documents. Still more particularly, the present invention relates to the prevention of identification document forgery, including, but not limited to, at the time of issuance.

### SUMMARY

In one or more embodiments of the present invention, a processor-implemented method manages an identification document (ID) that is displayed on an electronic device. One or more processors (e.g., within an identity document manager) receive a set of profile details about an entity. The processor(s) send the set of profile details about the entity to a blockchain system that generates a blockchain from the set of profile details about the entity. The processor(s) receive the blockchain from the blockchain system; generate a hash of the blockchain; generate a barcode from the hash of the blockchain; and transmit the barcode to an entity device. The processor(s) subsequently receive a new barcode from an entity verification device, along with a request from the entity verification device to validate the new barcode that is received from the entity verification device. The processor(s) compare information in the new barcode that is received from the entity verification device to information in the blockchain that the identity document manager received from the blockchain system. In response to the information in the new barcode that is received from the entity verification device matching information in the blockchain that the identity document manager received from the blockchain system, the processor(s) transmit entity authorization instructions to the entity verification device.

The described inventions are also implemented in a computer system and/or as a computer program product.

### BRIEF DESCRIPTION OF THE DRAWINGS

FIG. 1 depicts an exemplary system and network that is used in one or more embodiments of the present invention;

FIG. 2 illustrates a high-level overview of devices used in one or more embodiments of the present invention;

FIG. 3 depicts an exemplary embodiment of the present invention in which an identity document (ID) manager creates a blockchain-based barcode ID for a particular entity;

FIG. 4 illustrates an exemplary embodiment of the present invention in which the ID manager validates a barcode from an entity verification device;

FIG. 5 depicts an exemplary embodiment of the present invention in which the ID manager validates an identity of an entity using a two-factor authorization of the entity based on the barcode from the entity verification device and biometric readings of the entity;

FIG. 6 illustrates a high-level overview of an exemplary blockchain as used in one or more embodiments of the present invention;

FIG. 7 depicts an exemplary blockchain system as used in one or more embodiments of the present invention;

FIG. 8 depicts additional detail of an exemplary blockchain fabric as used in one or more embodiments of the present invention;

FIG. 9 illustrates a high-level use of a blockchain fabric in accordance with one or more embodiments of the present invention;

FIG. 10 is a high-level flow-chart of one or more steps performed in a processor-based method in accordance with one or more embodiments of the present invention;

FIG. 11 depicts a cloud computing environment according to an embodiment of the present invention; and

FIG. 12 depicts abstraction model layers of a cloud computer environment according to an embodiment of the present invention.

### DETAILED DESCRIPTION

In one or more embodiments, the present invention is a system, a method, and/or a computer program product at any possible technical detail level of integration. In one or more embodiments, the computer program product includes a computer readable storage medium (or media) having computer readable program instructions thereon for causing a processor to carry out aspects of the present invention.

The computer readable storage medium is a tangible device that is able to retain and store instructions for use by an instruction execution device. In one or more embodiments, the computer is, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein are capable of being downloaded to respective computing/processing devices from a computer readable storage medium or to an external computer or external storage device via a network, for example, the Internet, a local area network, a wide area network and/or a wireless network. In one or more embodiments, the network comprises copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one or more embodiments, computer readable program instructions for carrying out operations of the present invention comprise assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. In one or more embodiments, the computer readable program instructions execute entirely on the user's computer, partly on the user's computer, as a stand-alone software package, partly on the user's computer and partly on a remote computer or entirely on the remote computer or server. In the latter scenario and in one or more embodiments, the remote computer connected to the user's computer through any type of network, including a local area network (LAN) or a wide area network (WAN), or the connection is made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, are implemented by computer readable program instructions in one or more embodiments of the present invention.

In one or more embodiments, these computer readable program instructions are provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In one or more embodiments, these computer readable program instructions are also be stored in a computer readable storage medium that, in one or more embodiments, direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In one or more embodiments, the computer readable program instructions are also loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams represents a module, segment, or portion of instructions, which comprises one or more executable instructions for implementing the specified logical function(s). In some alternative implementations, the functions noted in the block occur out of the order noted in the figures. For example, two blocks shown in succession are, in fact, executed substantially concurrently, or the blocks are sometimes executed in the reverse order, depending upon the functionality involved. It will also be noted that, in one or more embodiments of the present invention, each block of the block diagrams and/or flowchart illustration, and combinations of blocks in the block diagrams and/or flowchart illustration, are implemented by special purpose hardware-based systems that perform the specified functions or acts or carry out combinations of special purpose hardware and computer instructions.

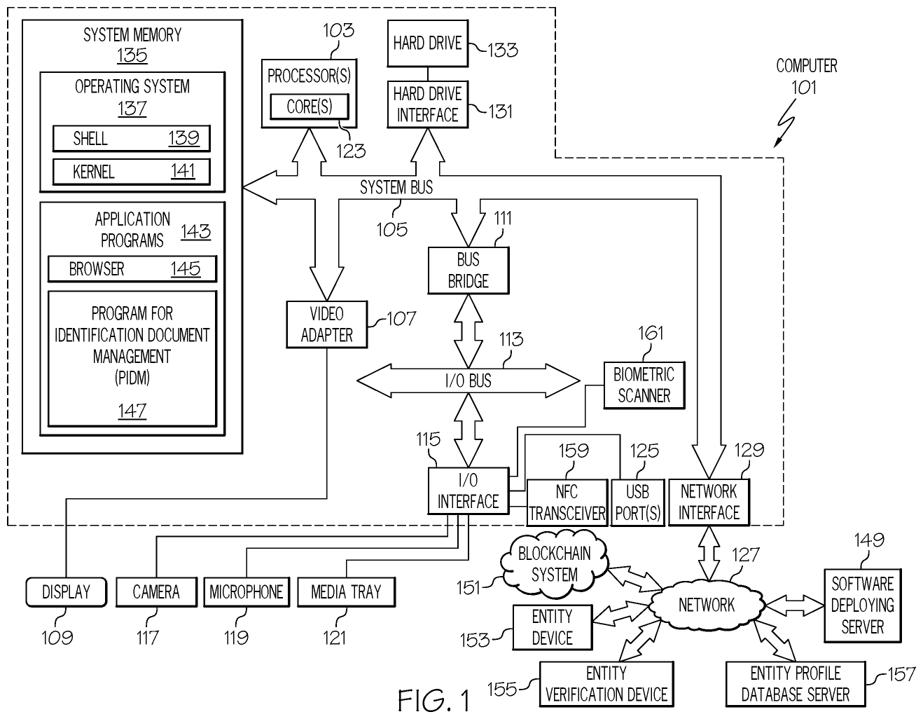

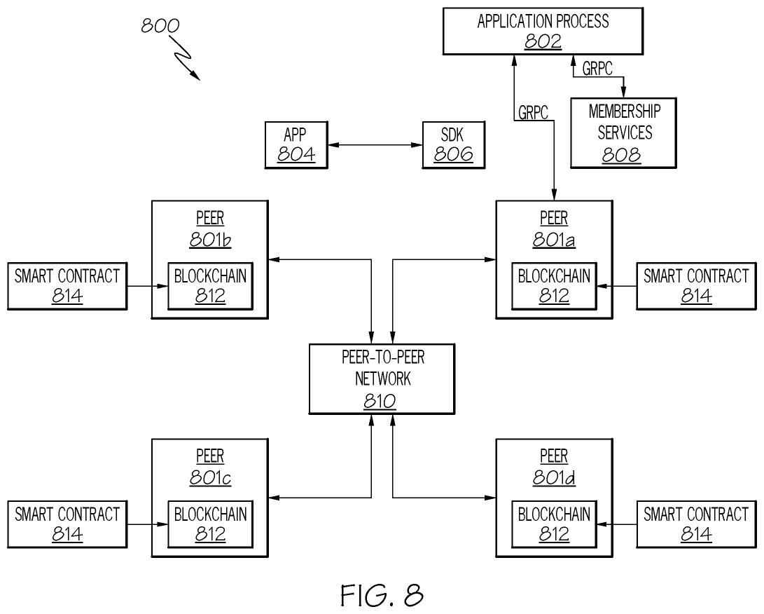

With reference now to the figures, and in particular to FIG. 1, there is depicted a block diagram of an exemplary system and network that are utilized in the one or more embodiments of the present invention. In accordance with various embodiments of the present invention, some or all of the exemplary architecture, including both depicted hardware and software, shown for and within computer 101 utilized by software deploying server 149 and/or devices within a network of blockchain system 151 and/or an entity device 153 and/or an entity verification device 155 and/or an entity profile database server 157 shown in FIG. 1, and/or peer blockchain nodes 801a-801d shown in FIG. 8. In one or more embodiments of the present invention, blockchain system 151, entity verification device 155, and/or entity profile database server 157 are components within computer 101.

In one or more embodiments of the present invention, exemplary computer 101 includes a processor 103 that is coupled to a system bus 105. Processor 103 utilizes one or more processors, each of which has one or more processor cores 123. A video adapter 107, which drives/supports a display 109 (which in one embodiment is a touch-screen display capable of detecting touch inputs onto the display 109), is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a mouse 119, a media tray 121 (which in one embodiment includes storage devices such as CD-ROM drives, multi-media interfaces, etc.), and external USB port(s) 125. While the format of the ports connected to I/O interface 115 is that which is known to those skilled in the art of computer architecture, including by not limited to universal serial bus (USB) ports.

As depicted, computer 101 is able to communicate with a software deploying server 149 and/or other devices/systems using a network interface 129. Network interface 129 is a hardware network interface, such as a network interface card (NIC), etc. In one or more embodiments, network 127 is an external network such as the Internet, or an internal network such as an Ethernet or a virtual private network (VPN). In one or more embodiments, network 127 is a wireless network, such as a Wi-Fi network, a cellular network, etc. As such, computer 101 and/or blockchain networked devices 151 and/or second computer 153 are devices capable of transmitting and/or receiving wireless and/or Internet broadcasts, such as private/public channel radio or television broadcasts, streaming broadcasts, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with software deploying server 149 and other systems.

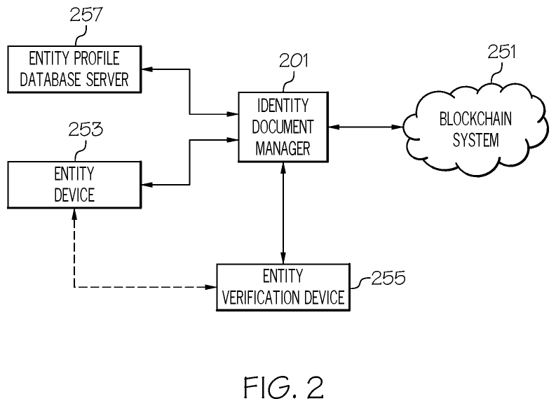

Application programs 143 in computer 101's system memory (as well as software deploying server 149's system memory) also include a Program for Identification Document Management (PIDM) 147. PIDM 147 includes code for implementing the processes described below, including those described in FIGS. 2-10. In one embodiment, computer 101 is able to download PIDM 147 from software deploying server 149, including in an on-demand basis, wherein the code in PIDM 147 is not downloaded until needed for execution. In one embodiment of the present invention, software deploying server 149 performs all of the functions associated with the present invention (including execution of PIDM 147), thus freeing computer 101 from having to use its own internal computing resources to execute PIDM 147.

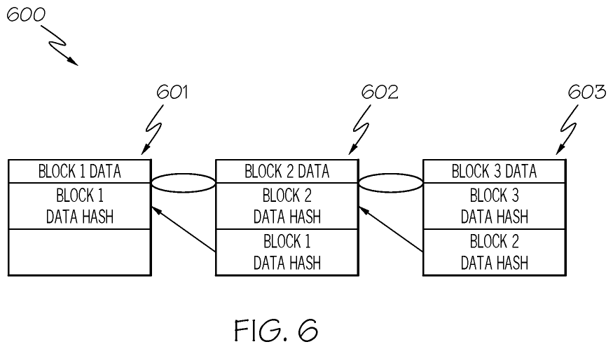

Additional detail of the architecture and operations performed by blockchain system 151 are presented in FIGS. 6-9.

An exemplary entity device 153 is a smart phone, which has a display that is able to display a barcode (e.g., a two-dimensional matrix barcode) that is generated using the processes described herein. Thus, in the present patent application, a “barcode” is defined as a graphical representation of data that is readable by a computer system and/or scanner.

An exemplary entity verification device 155 is a barcode scanner. In an embodiment of the present invention in which the identification document is an electronic passport stored on (or available for downloading to) the entity device 153, then an exemplary verification device 155 is an electronic passport reader at a country port of entry. In an embodiment of the present invention in which the identification document is an electronic identification document of an associate of an enterprise, a person who is authorized to enter a restricted area, etc., then an exemplary verification device 155 is a device that allows that person to enter the restricted area (e.g., a particular building, room, process area, etc.) upon presentation of a valid electronic identification document for that person.

An exemplary entity profile database server 157 is a server that provides profile information for one or more persons. In an embodiment of the present invention, entity profile database server 157 is just a feature provided by computer 101. Examples of profile information include, but are not limited to, a particular person's name, date of birth, home address, biometrics (e.g., facial profile, eye scan, heart rate signature, etc.), and/or information that describes and/or identifies a particular entity device 153 for which that person is authorized to use and display his/her electronic identification document.

In an embodiment of the present invention, computer 101 (and/or entity device 153 and/or entity verification device 155) includes a near-field communication (NFC) transceiver 159. NFC transceiver 159 is a hardware transceiver that affords wireless communication between one NFC-enabled device another NFC-enabled device (e.g., entity device 153 and/or entity verification device 155) when the two NFC-enabled devices are within a predefined distance of one another (e.g., with 1.6 inches of one another).

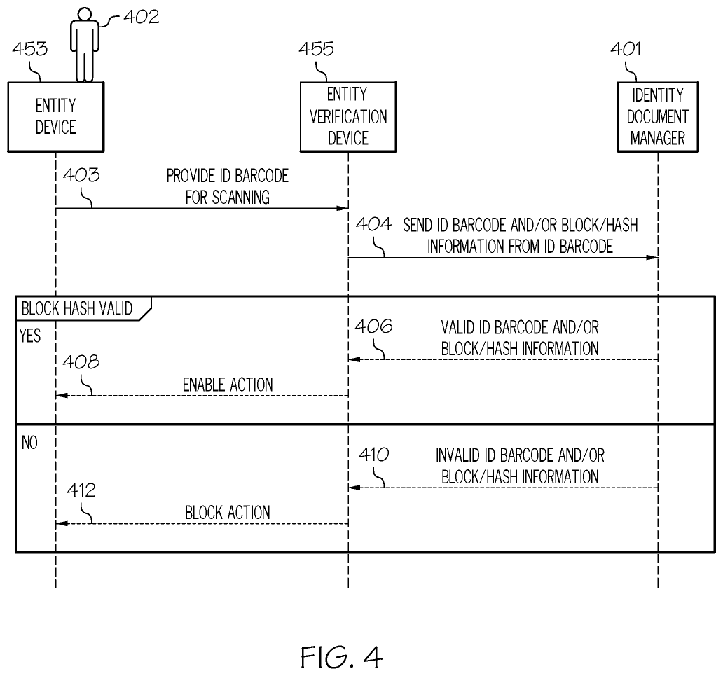

In an embodiment of the present invention, computer 101 (and/or entity device 153 and/or entity verification device 155) includes a biometric scanner 161. Biometric scanner 161 is a hardware device that is able to take a biometric reading of a particular person. For example, in an embodiment of the present invention, the biometric scanner 161 is a fingerprint scanner that captures an image of a user's fingerprint (e.g., when the user places his/her finger/thumb on a screen on the fingerprint scanner), and then digitizes the user's fingerprint image to capture a description of the swirls, lines, etc. that make up the user's fingerprint. In other embodiments of the present invention, the biometric scanner 161 capture biometric data and convert them into digital files for describing a shape and color of the person's iris (iris scanner), the person's speech pattern (voice scanner), the person's face (face scanner), a person's heartbeat pattern (e.g., an electrocardiograph ECG/EKG scanner), etc., all of which generate biometric data that is unique for a particular person. Once the biometric file is generated, it is transmittable to another device. For example, assume that entity verification device 155 includes the biometric scanner 161. Once the entity verification device 155 captures biometric data about a particular person, then that data is transmittable to computer 101, which functions as the identity document manager 401 shown in FIG. 4.

The hardware elements depicted in computer 101 are not intended to be exhaustive, but rather are representative to highlight essential components required by the present invention. For instance, in one or more embodiments computer 101 includes alternate memory storage devices such as magnetic cassettes, digital versatile disks (DVDs), Bernoulli cartridges, and the like. These and other variations are intended to be within the spirit and scope of the present invention.

One or more embodiments of the present invention provide a new, useful, and non-obvious solution to the problem of forged, stolen, and otherwise invalid personal identification documents (IDs), such as passports, member and/or associate IDs, security access IDs, etc., in which an unauthorized person is able to improperly enter a country, a restricted area, etc.

In order to address and provide a new and useful solution to this problem, one or more embodiments of the present invention utilize blockchain technology to prevent misuse of IDs such that they cannot be modified, used by an unauthorized person, etc.

One or more embodiments of the present invention use software-based identification document (ID) technology, with an inbuilt blockchain technology, such that carrying physical IDs (e.g., passports) is no longer necessary, and yet the ID is fully trusted.

In one or more embodiments, the present invention uses biometrics authentication technologies in a two-factor authorization, in which both the ID as well as currently-taken biometric readings are used to identify and authorize the person to whom the ID belongs.

Thus, one or more embodiments of the present invention utilize blockchain technology to create the user profile. Certain aspects of the user's personal information, such as name, date of birth, parents' names, spouse's name etc., along with user biometrics such as fingerprint information, facial features information, iris scan, etc. are used to arrive at a hash value (i.e., a value that is derived by a hash function that maps the user's personal information and/or biometrics, which are of an arbitrary size, to a unique data string of a fixed size). This hash value is then used to create the new block in the chain.

In an embodiment of the present invention, an identifier of an embedded radio frequency identification (RFID) tag, a universal unique identifier (UUID), etc. that contains the ID of the person is part of the hash that is used to create the new block in the chain. For example, if the ID is a paper passport (or other paper ID) that has an embedded RFID, then the identifier of that embedded RFID is part of the hash. If the ID is an electronic passport (or other electronic ID) on an electronic device (e.g., entity device 153 shown in FIG. 1), then that electronic device contains a UUID (e.g., within system memory 135) that identifies that particular electronic device. As such, the RFID or the UUID is part of the hash.

Whether the ID is paper or electronic, in one or more embodiments of the present invention, the hash is displayed as a barcode, which functions as the ID of the particular person. In one or more embodiments of the present invention, this barcode is a two-dimensional matrix barcode.

As the new hash is displayed as the two-dimensional matrix barcode on either the paper ID or the electronic ID, when the user passes an access control point (e.g., passport control, building access control, etc.), the user's ID is matched using the hash and cross-verifying it with the central identification repository, such as the identity document manager 201 shown in FIG. 2. If the hash matches, then the ID is deemed genuine and/or has been created via the proper channels.

By using blockchain technology, the present invention ensures that the ID is valid, since blockchains are essentially impervious to being attacked, due to their distributed and protected architecture.

Thus, in one or more embodiments of the present invention, IDs (e.g., passports) are issued to be carried in a user's mobile phone as a soft passport (i.e., software-based passport). By using near-field communications (NFCs) afforded by the NFC transceiver 159 shown in FIG. 1, the user's mobile phone is able to present the user's soft passport to a passport interrogation device, in order to exchange the passport information. In a further embodiment of the present invention, the user's fingerprint (as read by a fingerprint scanner that generates a digital image of the user's fingerprint) acts in a manner that is similar to an RFID tag identifier or an embedded chip (e.g., RFID) identifier. Such two-factor authentication systems provide an additional layer of flexibility to the user, since if the user's phone is lost/stolen/damaged or user changes the phone, then the user is able to notify the identity document manager, in order to revoke the old mobile phone's authorization to present the soft passport, and to enroll a new mobile phone for use in containing/presenting the user's passport. In an embodiment of the present invention, switching from the old mobile phone to the new mobile phone does not merely load the old soft passport barcode onto the new phone, but rather a new soft passport barcode is generated and loaded onto the new phone. That is, the old hash value of the passport is disabled, and a new hash value of the passport is enabled as the new phone is enabled, thereby making the process secured.

In an embodiment of the present invention, the two-factor authentication uses user biometrics to ensure that the person holding the passport is, in fact, the person the passport is issued to. If the passport holder is carrying the soft passport on his/her mobile phone, then that user's biometrics are used to ensure that the user is verified.

With reference now to FIG. 2, a high-level overview of devices used in one or more embodiments of the present invention is presented.

As shown in FIG. 2, an identity document (ID) manager 201 (analogous to computer 101 shown in FIG. 1) is in communication with one or more devices/servers/systems, some of which are components of ID manager 201 in various embodiments of the present invention.

Entity device 253 (analogous to entity device 153 shown in FIG. 1) is a device (e.g., a smart phone) that receives and stores a soft identification document (ID), such as a passport, an associate ID, etc.

Entity profile database server 257 (analogous to entity profile database server 157) is a computer that provides profiles of one or more entities (e.g., persons, equipment, etc.). If the entity is equipment, then the profile includes a description of the equipment, its unique identifier number, a description of its capabilities, its owner, etc. If the entity is a person, then the profile includes that person's name, address, relatives, occupation, etc.; and/or equipment identifiers of the entity device 253 that is used by that person; and/or biometric markers (e.g., fingerprint pattern, iris scan pattern, voice print, etc.) of that person.

As described herein the identity document manager 201 sends this profile information to a blockchain system 251 (analogous to blockchain system 151 shown in FIG. 1), which generates a block of information/data (described below) about the entity. This block of information/data is then used by the identity document manager 201 (or in another embodiment, by the blockchain system 251 itself, in order to provide additional security) to create an electronic ID of the entity.

Thereafter, if the entity device 253 presents the electronic ID to an entity verification device 255 (analogous to entity verification device 155 shown in FIG. 1), then the entity verification device 255 will send the electronic ID to the identity document manager 201, which verifies the electronic ID as being valid.

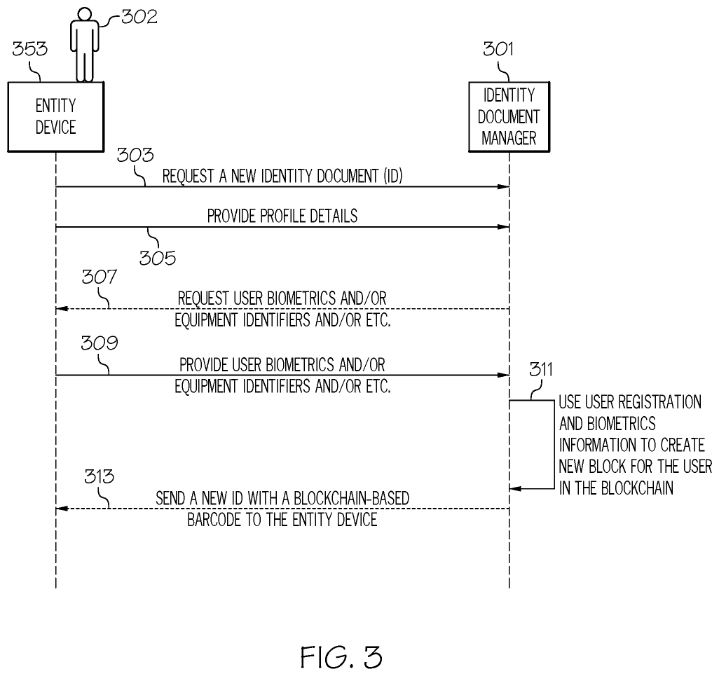

With reference now to FIG. 3, an exemplary embodiment of the present invention in which an identity document (ID) manager creates a blockchain-based barcode ID about a particular entity is presented.

As described in block 303, an entity device 353 (analogous to entity device 253 shown in FIG. 2) sends a request for a new identity document (e.g., a passport, a member ID, an access card, etc.) to an identity document manager 301 (analogous to identity document manager 201 shown in FIG. 2).

As described in block 305, the entity device 353 also sends profile details about the entity 302 that is using and/or otherwise associated with the entity device 353. For example, assuming that the entity 302 is a person, then the profile details include the name, address, date of birth, etc. of the entity 302.

As described in block 307, the identity document manager 301 optionally requests biometric information (e.g., fingerprint scan, iris scan, etc.) and/or equipment information (e.g., a unique identifier of the entity device 353, descriptions of hardware and/or software used by entity device 353, etc.). As shown in block 309, this information is provided by the entity device 353 to the identity document manager 301, which then sends this information to a blockchain fabric.

As described in block 311, the blockchain fabric creates a new block of data for the entity 302, which the identity document manager 301 uses to create an ID for the entity 302, which includes a blockchain-based barcode (i.e., a barcode hash of the block that is created by the blockchain fabric.

As described in block 313, the identity document manager 301 then sends this new ID for the entity (with the blockchain-based barcode) to the entity device 353, which stores it thereon as a software-based identity document for the entity 302.

With reference now to FIG. 4, an exemplary embodiment of the present invention in which the ID manager validates a barcode from an entity verification device is presented.

As shown in FIG. 4, assume that the entity device 453 (analogous to entity device 353 shown in FIG. 3) sends an ID barcode (generated as described in FIG. 3) to an entity verification device 455 (analogous to entity verification device 155 shown in FIG. 1), as described in block 403. For example, if entity device 453 is a smart phone, and entity 402 is a person whose passport is a soft passport that is stored in and displayed on that person's smart phone, then the entity verification device 455 is an optical scanner used by a customs office to verify the identity of the person when entering a country.

As shown in block 404, the entity verification device 455 then sends the ID barcode, and/or the block/hash information that was used to generate the ID barcode, to the identity document manager 401 (analogous to identity document manager 301 shown in FIG. 3), as described in block 404. The identity document manager 401 then compares this information to what it has on record.

That is, in one embodiment of the present invention, the identity document manager 401 has a copy of the two-dimensional ID barcode, which it simply compares (graphically) to the two-dimensional ID barcode that is sent from the entity verification device 455.

In another embodiment, the identity document manager 401 first extracts the data from the two-dimensional ID barcode using a reverse-lookup. That is, the two-dimensional ID barcode is correlated with the underlying information provided by the entity, such that this underlying information is retrieved by the identity document manager 401. More specifically, each set of data described in the two-dimensional ID barcode is associated with the underlying profile information provided by the entity, thus enabling the identity document manager 401 to locate the underlying profile information based on the two-dimensional ID barcode.

Once the identity document manager 401 determines whether or not the ID barcode and/or the underlying profile information matches what it has on file, it reports its findings to the entity verification device 455. That is, if the ID barcode and/or the underlying information about the entity 402 matches what the identity document manager 401 has on file, then a message is sent to the entity verification device 455 indicating that the ID barcode and/or block/hash information is valid, as shown in block 406. This allows the entity verification device 455 to enable an action to be performed by the entity device 453, as shown in block 408. For example, if the ID barcode is for a soft passport, then enabled action is an authorization for the entity 402 to be allowed passage into the country of destination.

However, if the ID barcode and/or the underlying information about the entity 402 does not match what the identity document manager 401 has on file, then a message is sent to the entity verification device 455 indicating that the ID barcode and/or block/hash information is not valid, as shown in block 410. This blocks the entity 402 from entering the country of destination, as shown in block 412.

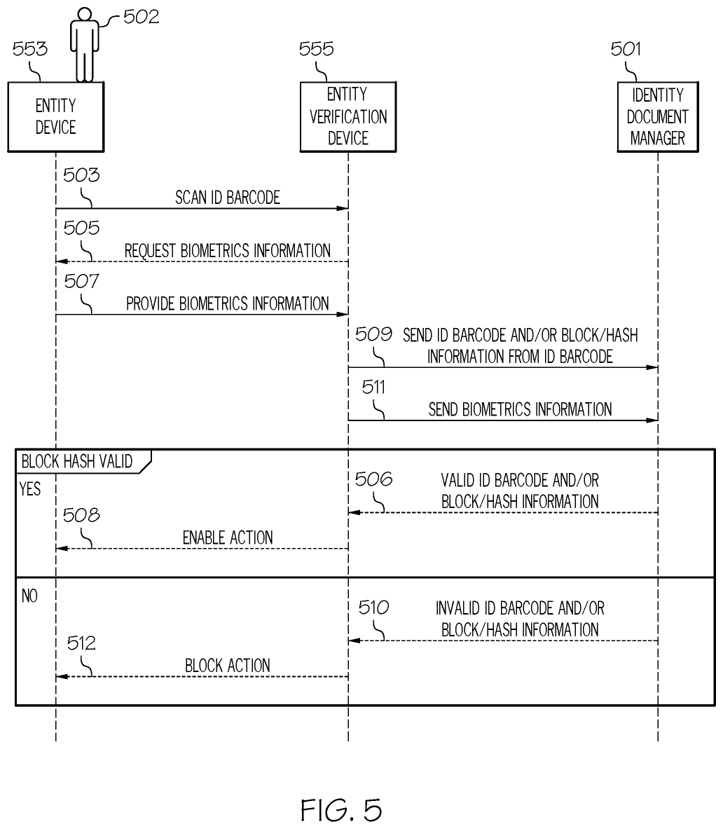

With reference now to FIG. 5, an exemplary embodiment of the present invention in which the ID manager validates an identity of an entity using a two-factor authorization of the entity based on the barcode from the entity verification device and biometric readings of the entity is presented.

FIG. 5 depicts an entity 502 (analogous to entity 402 shown in FIG. 4), an entity device 553 (analogous to entity device 453 shown in FIG. 4), an entity verification device 555 (analogous to entity verification device 455 shown in FIG. 4), and an identity document manger 501 (analogous to identity document manager 401 shown in FIG. 4).

As in block 403 in FIG. 4, the entity device 553 sends the ID barcode to the entity verification device 555 (e.g., by allowing the entity verification device 555 to scan the ID barcode, receive the ID barcode via a NFC connection, etc.), as described in block 503.

As shown in block 505, the entity verification device 555 is using a two-factor authentication system, and thus requests biometric information (e.g., fingerprint scan, facial scan, etc.) about the entity 502 from the entity device 553. As shown in block 507, the entity device 553 thus returns this requested biometric information to the entity verification device 555.

As shown in block 509, the entity verification device 555 sends the ID barcode and/or the block/hash information from the ID barcode to the identity document manager 501. In addition, and as shown in block 511, the current real-time biometrics information just provided by the entity device 553 (or alternatively, as collected by and provided by the entity verification device 555), is sent to the identity document manager 501.

As shown in block 506 (analogous to block 406 shown in FIG. 4), if the ID barcode and/or the underlying information about the entity 502 matches what the identity document manager 501 has on file, then a message is sent to the entity verification device 555 indicating that the ID barcode and/or block/hash information is valid. This allows the entity verification device 555 to enable an action to be performed by the entity device 553, as shown in block 508 (analogous to block 408 shown in FIG. 4).

However, if the ID barcode and/or the underlying information about the entity 502 does not match what the identity document manager 501 has on file, then a message is sent to the entity verification device 555 indicating that the ID barcode and/or block/hash information is not valid, as shown in block 510 (analogous to block 410 shown in FIG. 4). This blocks the entity 502 from entering the country of destination (block 512, analogous to block 412 shown in FIG. 4), since an alert is created on the entity verification device 555 indicating that the ID barcode is invalid.

With reference now to FIG. 6, a high-level overview of an exemplary blockchain as used in one or more embodiments of the present invention is presented.

As shown in FIG. 6, a blockchain 600 is essentially a collection of blocks of data, depicted for illustrative purposes in FIG. 6 as block 601, block 602, and block 603 (although in various embodiments of the present invention there are more, or possibly fewer, blocks in the blockchain 600). In a preferred embodiment of the present invention, each block is managed by a different computer. For example, block 601 is handled by a first computer (not shown); block 602 is handled by a second computer (not shown); and block 603 is handled by a third computer (not shown).

In an embodiment of the present invention, each block contains additional profile information about the entity 502 shown in FIG. 5. For example, in an embodiment of the present invention, the block 1 data in block 601 is the name of the entity 502; the block 2 data in block 602 is a date of birth of entity 502; and the block 3 data in block 603 is the address of the entity 502.

Each block includes data and one or more data hashes. As defined herein, a “hash” is a string of characters that represents and/or references another string of characters and/or data. In one or more embodiments of the present invention, a hash is a string of characters/data/numbers that is created from an original string that is longer than the hash. For example, assume that an original string 123456789 is hashed by a hashing algorithm to create the hash 9876, when is later used to re-create the original string 123456789 using a lookup table and/or a reverse hashing algorithm.

As shown in FIG. 6, assume that block 1 data has been hashed to create block 1 data hash, which is stored (along with the block 1 data) in block 601. Assume further that block 602 has a hash of the block 1 data, shown in FIG. 6 as block 1 data hash.

Assume now that new data is to be added to blockchain 600. This new data is shown as block 2 data in block 602. In order to retain/reconstruct the block 1 data (which is essentially also part of block 602), block 602 has a pointer to the block 1 data hash, which is used to reconstruct the block 1 data. Similarly, block 603 has new block 3 data, as well as a pointer to the block 2 data hash, thus allowing block 603 to reconstruct block 2 data. Thus, a “chain” of blocks of data are created, in order to form the blockchain 600. However, each block is only able to reconstruct the data of the immediately preceding block, thereby making the chain virtually impossible to improperly alter.

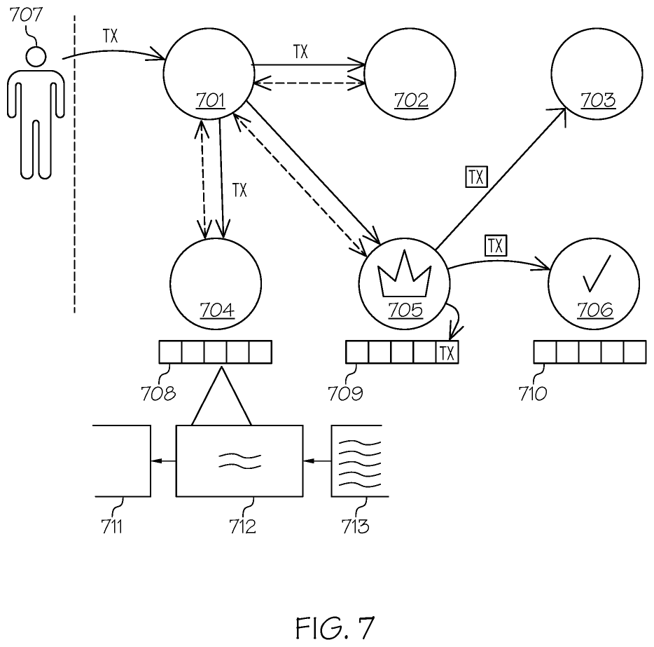

With reference now to FIG. 7, an illustration of another exemplary blockchain system as used in one or more embodiments of the present invention is presented. As shown in FIG. 7, computers 701, 702, 703, 704, 705, and 706 represent an exemplary peer-to-peer network of devices used to support a peer blockchain (in which more or fewer computers/machines form the peer-to-peer network of devices). Each of the computers 701, 702, 703, 704, 705 and 706 (which in various embodiments are telecommunication devices, portable computers, servers, etc.) in the peer-to-peer network has a same copy of data (e.g., data that represents transaction events), as held in ledgers stored within the depicted blockchains 708, 709, 710 that are associated with respective computers 704, 705, 706.

As shown in FIG. 7, a client 707 (e.g., a computer) sends a transaction Tx (e.g., a description of a trait of entity 502 shown in FIG. 5) to the client's peer (depicted as computer 701). Computer 701 then sends the transaction Tx to ledgers known as the depicted blockchains 708, 709, 710 that are associated with other peers, including the depicted computers 702, 704, 705.

Blocks within exemplary blockchain 708 are depicted as block 711, block 712, and block 713. Block 713 is depicted as a newest entry into a ledger held in blockchain 708, and includes not only the newest transactions but also a hash of the data from the older block 712, which includes a hash of the even older block 711. Thus, older blocks are made even more secure each time a new block is created, due to the hashing operations.

As shown in FIG. 7, computer 705 has been designated as a leader peer according to a consensus model of the peer-to-peer network. In order to be designated as the leader peer, computer 705 has either been pre-designated to be the leader peer (e.g., if the blockchain is used within a blockchain fabric that is protected by a firewall of an enterprise, and is not visible to the public), or else (in the case of a public blockchain fabric) is the first to “guess” what the data in Tx is. That is, computer 701 encrypted Tx with a known one-way encryption algorithm (e.g., Secure Hash Algorithm 2—“SHA-2”). Since this is a one-way encryption algorithm, there is no way to know what was used as the input by simply reverse-engineering the encryption. However, blockchain protocols require that the leading bits in the encrypted (hashed) data follow a certain pattern, such as eight leading zeros followed by other bits (e.g., “00000000xxxxxxxxxxxx”). Thus, computer 705 simply uses brute force to input many combinations of data into the SHA-2 algorithm until an output of “00000000xxxxxxxxxxxx” is achieved. Since the first eight bits were correct (“00000000”), then there is an assumption that the other bits (“xxxxxxxxxxxx”) are also correct, since the odds of getting “00000000” correct but not getting “xxxxxxxxxxxx” are extremely small. Note that while computer 705 is working on this problem (of guessing what the input data to the SHA-2 algorithm by computer 701 is), other computers such as computers 701-704 and 706 are also working on the problem.

Assume now that computer 705 won the “race” to decrypt Tx before computers 701-704 and 706. Thus, computer 705 will send the data (“00000000xxxxxxxxxxxx”) in a newly-encrypted form (using a key provided by computer 701) to one or more of computers 701-704 and 706. One or more of computers 701-704 and 706 will then check computer 705's work. Once a predefined quantity of peer computers from computers 701-704 and 706 agree that the decrypted value of Tx is correct, then computer 705 will be designated as the leader peer for Tx, and will be designated as the leader peer. That is, the nodes/computers that receive the new block/transaction (Tx) then attempt to validate the new block/transaction. If enough (i.e., some predefined quantity/percentage) of the nodes/computers validate the new block/transaction, then the new block/transaction is deemed valid for the entire peer-to-peer network of computers 701-706 and is added to the blockchains (including the depicted blockchains 708, 709, 710) associated with all of the nodes/peers/computers 701-706.

As such, the leader peer (computer 705) organizes all transactions from the nodes/peers/computers/telecommunication devices 701-706, and then shares new blocks/transactions (Tx) with other nodes (e.g., computers 703, 706) as depicted.

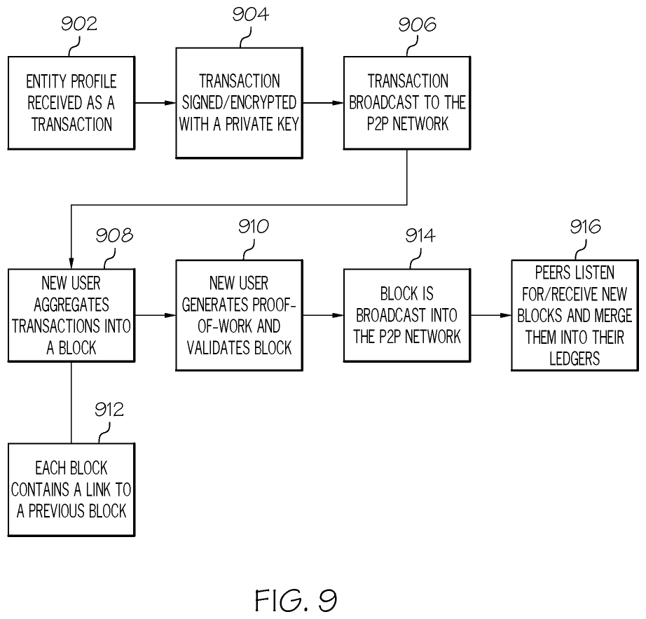

With reference now to FIGS. 8-9, additional detail of a blockchain and its operation as used by the present invention is presented.

In one or more embodiments of the present invention, a blockchain fabric, such as blockchain fabric 800 depicted in FIG. 8, is used to provide the infrastructure (e.g. execution of the chaincodes) and services (e.g., membership services such as identity management) for securely and transparently storing, tracking and managing transactions on a “single point of truth”. The blockchain fabric 800 maintains a verifiable record (of the single point of truth) of every single transaction ever made within the system. Once data are entered onto the blockchain, they can never be erased (immutability) or changed. That is, a change to a record would be regarded as issuing/introducing a new transaction. Prohibition of such thus ensures auditability and verifiability of data.

The blockchain fabric 800 (also known as the “blockchain system”, “open blockchain” or “hyperledger fabric”) is based on a distributed database of records of all transactions or digital events that have been executed and shared among participating parties. An individual transaction in the blockchain is validated or verified through a consensus mechanism incorporating a majority of the participants in the system. This allows the participating entities to know for certain that a digital event happened by creating an irrefutable record in a permissioned public ledger.

When a transaction is executed, its corresponding chaincode is executed by several validating peers of the system. For example, as shown in FIG. 8, peers 801a-801d (i.e., other computers, servers, etc.) establish the validity of the transaction parameters and, once they reach consensus, a new block is generated and appended onto the blockchain network. That is, an application process 802 running on a client (e.g., client 707 shown in FIG. 7) executes an application such as the depicted App 804, causing a software development kit (SDK) 806 to communicate using general remote procedure calls (grpc) to membership services 808 that support the peer-to-peer network 810 that supports the blockchain 812 using the peers 801a-801d.

Exemplary operation of the open blockchain fabric 800 shown in FIG. 8 is presented in FIG. 9. As described in step 902, an entity profile (e.g., as described in FIG. 3) is received as a transaction (e.g., adding a new feature to an entity's profile). As shown in step 904, the client (e.g., computer 701 shown in FIG. 7 or peer 801a shown in FIG. 8) signs and encrypts the transaction with a private key, such as SHA-2. This SHA-2-encrypted transaction is then broadcast to the peer-to-peer network 810 shown in FIG. 8, as described in step 906. A new user (e.g., peer 801c) aggregates the transaction(s) into blockchain 812, as shown in step 908. As shown in box 912, each block contains a link to a previous block. The newly-revised blockchain 812 is validated by one or more of the other peers in peers 801a-801d (step 910), and is then broadcast to the peers 801a-801b and peer 801d, as described in step 914. These peers 801a-801b and peer 801d listen for and receive the new blocks and merge them into their copies of blockchain 812 (step 916).

Thus, the open blockchain fabric 800 shown in FIG. 8 is a blockchain deployment topology that provides a distributed ledger, which persists and manages digital events, called transactions, shared among several participants, each having a stake in these events. The ledger can only be updated by consensus among the participants. Furthermore, once transactions are recorded, they can never be altered (they are immutable). Every such recorded transaction is cryptographically verifiable with proof of agreement from the participants, thus providing a robust provenance mechanism tracking their origination.

As such, a blockchain fabric uses a distributed network to maintain a digital ledger of events, thus providing excellent security for the digital ledger, since the blockchain stored in each peer is dependent upon earlier blocks, which provide encryption data for subsequent blocks in the blockchain.

That is, the open blockchain fabric 800 provides a decentralized system in which every node in a decentralized system has a copy of the blockchain. This avoids the need to have a centralized database managed by a trusted third party. Transactions are broadcast to the network using software applications. Network nodes can validate transactions, add them to their copy and then broadcast these additions to other nodes. However, as noted above, the blockchain is nonetheless highly secure, since each new block is protected (e.g., encrypted) based on one or more previous blocks.

Returning to FIG. 8, associated with each copy of the blockchain 812 is a copy of a smart contract 814. Smart contract 814 describes how blockchain 812 is to be managed, used, and/or shared. For example, assume that smart contract 814 states that if blockchain fabric 800 receives a string that describes the data in the ID for entity 302 (see FIG. 3), then blockchain fabric 800 is directed to compare that string with the data found in the blockchain 812. The results of this comparison are then sent to the identity document manager 501 and/or the entity verification device 555 and/or the entity device 553 shown in FIG. 5.

For example, if the blockchain fabric 800 determines that the data represented by the ID barcode is the same as the data represented by the blockchain 812, then this match is sent to the identity document manager 501, resulting in the enabled action shown in block 508 shown in FIG. 5.

Alternatively, if the blockchain fabric 800 determines that the data represented by the ID barcode is not the same as the data represented by the blockchain 812, then this failure to match is sent to the entity verification device 555, resulting directly in the blocked action shown in block 512 shown in FIG. 5.

Alternatively, if the blockchain fabric 800 determines that the data represented by the ID barcode is the same as the data represented by the blockchain 812, then this match is sent to the entity device 553, resulting in the entity device 553 being blocked from presenting the ID barcode to the entity verification device 555 shown in FIG. 5.

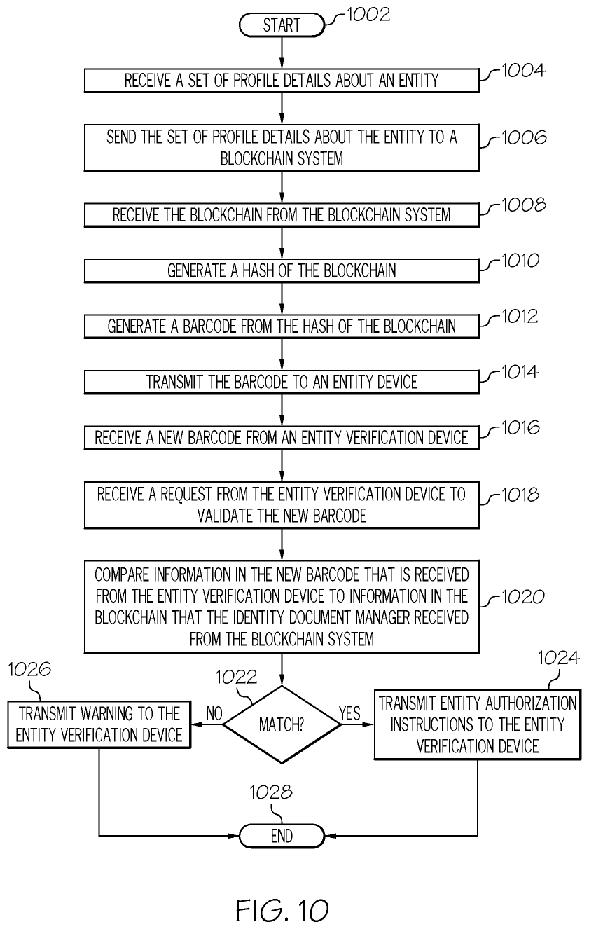

With reference now to FIG. 10, a high-level flow-chart of one or more steps performed in a processor-based method in accordance with one or more embodiments of the present invention is presented.

After initiator block 1002, one or more processors (e.g., within the identity document manager 501 shown in FIG. 5) receive (e.g., from entity device 553) a set of profile details (e.g., non-biometric information such as name, date of birth, etc.; biometric information such as fingerprint, facial scan, etc.; and/or identification of an entity device used by the entity) about an entity (e.g., entity 502 shown in FIG. 5), as described in block 1004.

As described in block 1006, the processor(s) send, to a blockchain system (e.g., blockchain system 151 shown in FIG. 1) the set of profile details about the entity. As described herein, and particularly in FIGS. 2-3 and FIGS. 6-9, the blockchain system generates a blockchain from the set of profile details about the entity.

As described in block 1008, the processor(s) receive the blockchain from the blockchain system.

As described in block 1010, the processor(s) then generate a hash of the blockchain.

As described in block 1012, the processor(s) then generate a barcode from the hash of the blockchain.

As described in block 1014, the processor(s) then transmit the barcode to an entity device (e.g., entity device 553 shown in FIG. 5), which stores the barcode thereon.

As described in block 1016, the processor(s) subsequently receive a new barcode from an entity verification device (e.g., entity verification device 555 shown in FIG. 5).

As described in block 1018, the processor(s) receive a request from the entity verification device to validate the new barcode that is received from the entity verification device.

As described in block 1020, the processor(s) compare information in the new barcode that is received from the entity verification device to information in the block that the identity document manager received from the blockchain system.

If the information in the new barcode and the information in the block that the identity document manager received from the blockchain system match (query block 1022), then the processor(s) transmit entity authorization instructions to the entity verification device, such as authorization for the entity to enter a certain area, etc., as shown in block 1024. However, if the information in the new barcode and the information in the block that the identity document manager received from the blockchain system do not match (query block 1022), then the action desired by the entity is blocked and/or a warning is sent to the entry verification device (block 1026).

The flow-chart ends at terminator block 1028.

In an embodiment of the present invention, the entity authorization instructions unlock a device that affords physical passage of the entity. For example, assume that the ID barcode is a barcode that, when scanned by a scanner or otherwise read by a control device, allows the entity 502 to enter a particular area, such as a certain restricted building, room, etc. Thus, if the ID barcode is verified as being valid (as described herein), then the lock that controls access to this area is unlocked, thus allowing the entity 502 to enter the building, room, etc.

In an embodiment of the present invention, biometric information of the entity/user is included in the set of profile details about the entity, and thus is part of the barcode that is generated from the hash of the blockchain, which was created from the set of profile details about the entity. However, in another embodiment, the bar code only contains non-biometric details (e.g., the name and address of the entity, and/or an identifier of the entity device, etc.). As such, in this embodiment the two-factor authorization process 1) uses the non-biometric details found in the barcode, and 2) biometric information about the user/entity. For example, assume that the barcode is a soft passport that is being presented by a user using the entity device 453 shown in FIG. 4. After confirming that the soft passport is valid (e.g., by the identity document manager 401 shown in FIG. 4) after being scanned by the entity verification device 455, a user of the entity verification device 455 (which includes the biometric scanner 161 shown in FIG. 1) directs the holder of the soft passport to present a real-time biometric to the biometric scanner 161 shown in FIG. 1. For example, in an embodiment of the present invention, the entity verification device 455 includes a fingerprint scanner. As such, the user of the entity verification device 455 directs the user to place his/her thumb/finger on the fingerprint scanner, which captures a pattern of the fingerprint on the user's thumb/finger. This captured pattern is then sent to the identity document manager 401, which verifies that 1) the soft passport described in the barcode is valid, and 2) that the person presenting the soft passport is in fact the authorized holder of the soft passport by comparing the fingerprint that was just provided to the entity verification device 455 shown in FIG. 4 to a stored copy of the authorized user's fingerprint file found in the entity profile database server 157 shown in FIG. 1.

Thus, in an embodiment of the present invention, in which the entity is a person, the identity document manager receives a set of biometric data about the person from the entity verification device. The identity document manager compares the set of biometric data about the person that is received from the entity verification device to biometric data of a known authorized holder of an identity document. In response to the set of biometric data about the person that is received from the entity verification device matching the biometric data of the known authorized holder of the identity document, the identity document manager transmits a message to the entity verification device confirming that the person is the known authorized holder of the identity document.

As described herein, the operations for generating and comparing the original ID barcode to the new barcode (received from the entity verification device) are performed by the blockchain (in accordance with the smart contract 814 shown in FIG. 8). As such, the blockchain system is (i.e., performs the function of) the identity document manager.

While the present invention has been described primarily as validating an information document (ID) for an entity that is a person, in other embodiments of the present invention the entity is a non-entity, either biologic or non-biologic. Thus, in an embodiment of the present invention, in which the entity is an animal (e.g., a terrestrial animal, an aquatic animal, etc.), the ID being validated verifies the identity of the animal. Once validated, the ID can be used to open a gate for that animal, track the location of the animal, etc.

In an embodiment of the present invention in which the entity is a non-biologic entity (e.g., a unit of mobile equipment such as a vehicle), the ID being validated verifies the identity of that device/vehicle/equipment. Once validated, the ID can be used to open a gate for the vehicle to pass through, enable the equipment to communicate with another device that is proximate to it, etc.

In one or more embodiments, the present invention is implemented using cloud computing. Nonetheless, it is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model includes at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but still is able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. In one or more embodiments, it is managed by the organization or a third party and/or exists on-premises or off-premises.

Community cloud: the cloud infrastructure is shared by several organizations and supports a specific community that has shared concerns (e.g., mission, security requirements, policy, and compliance considerations). In one or more embodiments, it is managed by the organizations or a third party and/or exists on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

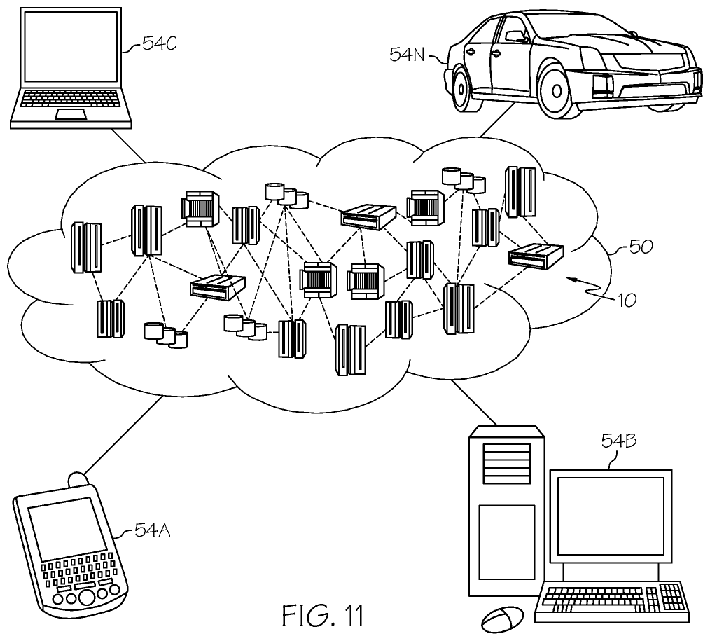

Referring now to FIG. 11, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N communicate with one another. Furthermore, nodes 10 communicate with one another. In one embodiment, these nodes are grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 11 are intended to be illustrative only and that computing nodes 10 and cloud computing environment 50 can communicate with any type of computerized device over any type of network and/or network addressable connection (e.g., using a web browser).

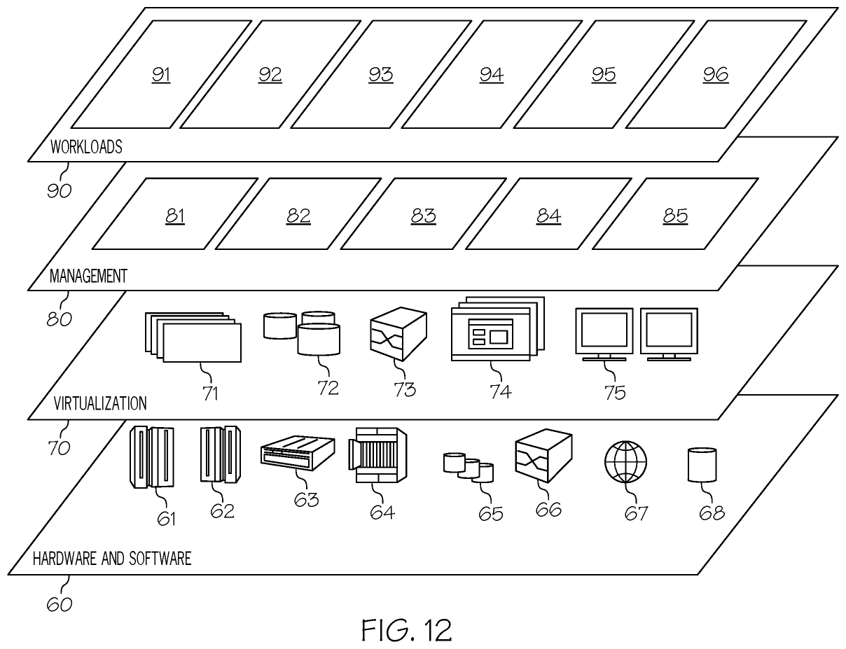

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities that are provided in one or more embodiments: virtual servers 71; virtual storage 72; virtual networks 73, including virtual private networks; virtual applications and operating systems 74; and virtual clients 75.

In one example, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment are utilized in one or more embodiments. Examples of workloads and functions which are provided from this layer include: mapping and navigation 91; software development and lifecycle management 92; virtual classroom education delivery 93; data analytics processing 94; transaction processing 95; and blockchain-based identification document processing 96, which performs one or more of the features of the present invention described herein.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

In one or more embodiments of the present invention, any methods described in the present disclosure are implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, in one or more embodiments of the present invention any software-implemented method described herein is emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method comprising:
sending, to a blockchain system, a set of profile details about an entity, wherein the blockchain system generates a blockchain from the set of profile details about the entity;
generating a barcode from a hash of the blockchain;
transmitting the barcode to an entity device;
receiving a new barcode and a request from an entity verification device to validate the new barcode;
comparing information in the new barcode that is received from the entity verification device to information in the blockchain that was received from the blockchain system; and
in response to the information in the new barcode that is received from the entity verification device matching information in the blockchain that was received from the blockchain system, transmitting entity authorization instructions to the entity verification device.

2. The method of claim 1, wherein the set of profile details comprises non-biometric information about the entity.

3. The method of claim 1, wherein the set of profile details comprises biometric information about the entity.

4. The method of claim 1, wherein the set of profile details comprises an identification of the entity device.

5. The method of claim 1, wherein the entity authorization instructions unlock a device that affords physical passage of the entity.

6. The method of claim 1, wherein the blockchain system is an identity document manager.

7. The method of claim 1, wherein the entity is a person, and wherein the method further comprises:
receiving a set of biometric data about the person from the entity verification device;
comparing the set of biometric data about the person that is received from the entity verification device to biometric data of a known authorized holder of an identity document;
in response to the set of biometric data about the person that is received from the entity verification device matching the biometric data of the known authorized holder of the identity document, transmitting a message to the entity verification device confirming that the person is the known authorized holder of the identity document.

8. A computer program product for managing an identification document, wherein the computer program product comprises a non-transitory computer readable storage device having program instructions embodied therewith, the program instructions readable and executable by a computer to perform a method comprising:
sending, to a blockchain system, a set of profile details about an entity, wherein the blockchain system generates a blockchain from the set of profile details about the entity;
generating a barcode from a hash of the blockchain;
transmitting the barcode to an entity device;
receiving a new barcode and a request from an entity verification device to validate the new barcode;
comparing information in the new barcode that is received from the entity verification device to information in the blockchain that was received from the blockchain system; and
in response to the information in the new barcode that is received from the entity verification device matching information in the blockchain that was received from the blockchain system, transmitting entity authorization instructions to the entity verification device.

9. The computer program product of claim 8, wherein the set of profile details comprises non-biometric information about the entity.

10. The computer program product of claim 8, wherein the set of profile details comprises an identification of the entity device.

11. The computer program product of claim 8, wherein the entity authorization instructions unlock a device that affords physical passage of the entity.

12. The computer program product of claim 8, wherein the method further comprises:
storing the barcode as a stored barcode;
comparing the stored barcode to the new barcode that is received from the entity verification device; and
in response to the stored barcode matching the barcode that is received from the entity verification device, transmitting additional entity authorization instructions to the entity verification device.

13. The computer program product of claim 8, wherein the program instructions are provided as a service in a cloud environment.

14. A computer system comprising one or more processors, one or more computer readable memories, and one or more computer readable storage mediums, and program instructions stored on at least one of the one or more computer readable storage mediums for execution by at least one of the one or more processors via at least one of the one or more computer readable memories to perform a method comprising:
sending, to a blockchain system, a set of profile details about an entity, wherein the blockchain system generates a blockchain from the set of profile details about the entity;
generating a barcode from a hash of the blockchain;
transmitting the barcode to an entity device;
receiving a new barcode and a request from an entity verification device to validate the new barcode;
comparing information in the new barcode that is received from the entity verification device to information in the blockchain that was received from the blockchain system; and
in response to the information in the new barcode that is received from the entity verification device matching information in the blockchain that was received from the blockchain system, transmitting entity authorization instructions to the entity verification device.

15. The computer system of claim 14, wherein the set of profile details comprises non-biometric information about the entity.

16. The computer system of claim 14, wherein the set of profile details comprises biometric information about the entity.

17. The computer system of claim 14, wherein the set of profile details comprises an identification of the entity device.

18. The computer system of claim 14, wherein the entity authorization instructions unlock a device that affords physical passage of the entity.

19. The computer system of claim 14, wherein the method further comprises:
storing the barcode as a stored barcode;
comparing the stored barcode to the new barcode that is received from the entity verification device; and
in response to the stored barcode matching the new barcode that is received from the entity verification device, transmitting additional entity authorization instructions to the entity verification device.

20. The computer system of claim 14, wherein the program instructions are provided as a service in a cloud environment.
